(19) United States
(12) Patent Application Publication
(10) Pub. No.: US 2016/0105894 A1
(43) Pub. Date: Apr. 14, 2016

(54) eMBMS Management Method, Multimedia Broadcast Multicast Service Coordination Entity, and Base Station

(71) Applicant: Huawei Technologies Co., Ltd., Shenzhen (CN)

(72) Inventors: Zhiqiang Lu, Shanghai (CN); Qiandong Ren, Shanghai (CN)

(21) Appl. No.: 14/975,744

(22) Filed: Dec. 19, 2015

Related U.S. Application Data
(63) Continuation of application No. PCT/CN2013/077676, filed on Jun. 21, 2013.

(51) Int. Cl. H04W 72/04; H04L 29/06

(52) U.S. Cl. CPC H04W 72/0486; H04L 65/4076

(57) ABSTRACT

The present invention relates to an evolved multimedia broadcast multicast service (eMBMS) management method and apparatus. The method is implemented by a multimedia broadcast multicast service coordination entity (MCE). Load information sent by a base station is received by the MCE. The MCE manages eMBMS resources according to the received load information.

This application is a continuation of International Application No. PCT/CN2013/077676, filed on Jun. 21, 2013, which is hereby incorporated by reference in its entirety.

### TECHNICAL FIELD

The present invention relates to an eMBMS (evolved multimedia broadcast multicast service) management method, a multimedia broadcast multicast service coordination entity (MCE), and a base station, and in particular, to an eMBMS management method that enables the eMBMS to run in coordination with another service, and an MCE and a base station to which the management method is applied.

### BACKGROUND

To effectively utilize mobile network resources, the 3rd Generation Partnership Project (3GPP) proposes a multimedia broadcast multicast service (MBMS), in hopes of providing diversified multimedia services in a mobile network, so as to follow development trend of mobile data in the future. The support of eMBMS in a long term evolution (LTE) system is provided to offer streaming and instant broadcasting services of higher quality.

FIG. 1 is a diagram illustrating a conventional logical architecture of the eMBMS, where the logical architecture mainly includes the following logical entities: a mobility management entity (MME), an MBMS gateway (MBMS-GW), a multimedia broadcast multicast service coordination entity (MBMS Coordination Entity, MCE), a base station (for example, an evolved NodeB, an eNB, or another type of base station), and M1, M2 and M3 interfaces. The MCE is responsible for allocating radio resources of all base stations in an MBSFN (multicast/broadcast over single frequency network) area, and the base station is responsible for serving users of all cells covered by the base station in the MBSFN area. The M1 interface is a communications interface between the MBMS gateway and the base station, the M2 interface is a communications interface between the MCE and the base station, and the M3 interface is a communications interface between the MME and the MCE.

However, in a mobile network to which both an eMBMS and another service (for example, a unicast service such as a call service) are applied, a conflict between the eMBMS and the another service may occur. For example, the occupation of subframes by a PMCH (physical multicast channel) of the eMBMS reduces the amount of PRB (physical resource block) resources that can be used by a common LTE service, and a unicast service such as a call service probably cannot be supported in time despite the fact that a relatively high priority is assigned to the unicast service. This leads to a call failure or a decrease in call quality, which in turn affects user experience.

### SUMMARY

In view of this, embodiments of the present invention provide an eMBMS management method, an MCE, and a base station, so as to effectively manage the eMBMS, thereby eliminating or reducing conflicts between the eMBMS and another service to enable the two services to run in coordination with each other.

A first aspect provides an evolved multimedia broadcast multicast service (eMBMS) management method, where the method includes: receiving, by a multimedia broadcast multicast service coordination entity (MCE), load information sent by a base station; and managing, by the MCE, eMBMS resources according to the received load information.

In a first possible implementation of the first aspect, the managing, by the MCE, eMBMS resources according to the received load information includes, when the load information indicates that a load level of the base station is greater than or equal to a first threshold, making, by the MCE, the base station exit a multicast/broadcast over single frequency network (MBSFN) area, or making at least one cell served by the base station exit an MBSFN area.

With reference to the first possible implementation of the first aspect, in a second possible implementation, the making at least one cell served by the base station exit an MBSFN area includes making, according to a descending order of loads of the cells, at least one of the cells served by the base station exit the MBSFN area.

With reference to the first or the second possible implementation of the first aspect, in a third possible implementation, the managing, by the MCE, eMBMS resources according to the received load information further includes, when the load information indicates that the load level of the base station is less than or equal to a second threshold, making, by the MCE, the base station or at least one of the cells served by the base station join the MBSFN area.

In a fourth possible implementation of the first aspect, the managing, by the MCE, eMBMS resources according to the received load information includes: determining an overall load level of an MBSFN area according to the load information; and, when the overall load level of the MBSFN area is greater than or equal to a third threshold, reducing, by the MCE, an amount of resources occupied by the eMBMS service in the MBSFN area.

With reference to the fourth possible implementation of the first aspect, in a fifth possible implementation, the managing, by the MCE, eMBMS resources according to the received load information further includes, when the overall load level of the MBSFN area is less than or equal to a fourth threshold, increasing, by the MCE, the amount of resources occupied by the eMBMS service in the MBSFN area.

In a sixth possible implementation of the first aspect, the managing, by the MCE, eMBMS resources according to the received load information includes, when the load information indicates that a load level of the base station is greater than or equal to a fifth threshold, reducing, by the MCE, an amount of resources occupied by the eMBMS service of the base station.

With reference to the sixth possible implementation of the first aspect, in a seventh possible implementation, the managing, by the MCE, eMBMS resources according to the received load information further includes, when the load information indicates that the load level of the base station is less than or equal to a sixth threshold, increasing, by the MCE, the amount of resources occupied by the eMBMS service of the base station.

With reference to the first aspect and any one of the first to the seventh possible implementations of the first aspect, in an eighth possible implementation, the load information received by the MCE is overall load information of the base station and/or load information of the cells served by the base station.

With reference to the first aspect and any one of the first to the eighth possible implementations of the first aspect, in a ninth possible implementation, before the MCE receives the load information, the method further includes sending, by the MCE, a query request to the base station, where the query request is used for instructing the base station to send the load information.

With reference to the first aspect and any one of the first to the ninth possible implementations of the first aspect, in a tenth possible implementation, when the base station and the MCE are in a same communications network, the load information is carried in M2 interface protocol signaling.

With reference to the tenth possible implementation of the first aspect, in an eleventh possible implementation, the M2 interface protocol signaling is any one or more of the following signaling: interface reset signaling; interface setup signaling; error indication signaling; configuration update signaling; and eMBMS scheduling information signaling.

With reference to the first aspect and any one of the first to the ninth possible implementations of the first aspect, in a twelfth possible implementation, when the base station and the MCE are in different communications networks, the load information is carried in a radio access network information management RIM message.

With reference to the first aspect and any one of the first to the twelfth possible implementations of the first aspect, in a thirteenth possible implementation, the method further includes sending, by the MCE, QoS information to the base station.

A second aspect provides an evolved multimedia broadcast multicast service (eMBMS) management method, where the method includes obtaining, by a base station, load information; and sending, by the base station, the load information to a multimedia broadcast multicast service coordination entity (MCE), where the load information is used for guiding the MCE through eMBMS resource management.

In a first possible implementation of the second aspect, the load information is overall load information of the base station and/or load information of cells served by the base station.

With reference to the second aspect and the first possible implementation of the second aspect, in a second possible implementation, before the base station sends the load information to the MCE, the method further includes receiving, by the base station, a query request from the MCE, where the query request is used for instructing the base station to send the load information.

With reference to the second aspect and any one of the first and the second possible implementations of the second aspect, in a third possible implementation, when the base station and the MCE are in a same communications network, the load information is carried in M2 interface protocol signaling.

With reference to the third possible implementation of the second aspect, in a fourth possible implementation, the M2 interface protocol signaling is any one or more of the following signaling interface reset signaling; interface setup signaling; error indication signaling; configuration update signaling; and eMBMS scheduling information signaling.

With reference to the second aspect and any one of the first and the second possible implementations of the second aspect, in a fifth possible implementation, when the base station and the MCE are in different communications networks, the load information is carried in a radio access network information management RIM message.

With reference to the second aspect and any one of the first to the fifth possible implementations of the second aspect, in a sixth possible implementation, the method further includes receiving, by the base station, QoS information from the MCE.

A third aspect provides a multimedia broadcast multicast service coordination entity (MCE), where the MCE includes a receiving module, configured to receive load information sent by a base station; and a management module, configure to manage eMBMS resources according to the received load information.

In a first possible implementation of the third aspect, the management module includes a first management unit, configured to: when the load information indicates that a load level of the base station is greater than or equal to a first threshold, make the base station exit a multicast/broadcast over single frequency network (MBSFN) area, or make at least one cell served by the base station exit an MBSFN area.

With reference to the first possible implementation of the third aspect, in a second possible implementation the first management unit makes, according to a descending order of loads of the cells, at least one of the cells served by the base station exit the MBSFN area.

With reference to the second or the third possible implementation of the third aspect, in a fourth possible implementation, the management module further includes a second management unit, configured to: when the load information indicates that the load level of the base station is less than or equal to a second threshold, make the base station or at least one cell served by the base station join the MBSFN area.

In a fifth possible implementation of the third aspect, the management module includes a determining unit, configured to determine an overall load level of an MBSFN area according to the load information; and a third management unit, configured to: when the overall load level of the MBSFN area is greater than or equal to a third threshold, reduce an amount of resources occupied by the eMBMS service in the MBSFN area.

With reference to the fifth possible implementation of the third aspect, in a sixth possible implementation, the management module further includes a fourth management unit, configured to: when the overall load level of the MBSFN area is less than or equal to a fourth threshold, increase the amount of resources occupied by the eMBMS service in the MBSFN area.

In a seventh possible implementation of the third aspect, the management module includes a fifth management unit, configured to: when the load information indicates that a load level of the base station is greater than or equal to a fifth threshold, reduce an amount of resources occupied by the eMBMS service of the base station.

With reference to the seventh possible implementation of the third aspect, in an eighth possible implementation, the management module further includes a sixth management unit, configured to: when the load information indicates that the load level of the base station is less than or equal to a sixth threshold, increase the amount of resources occupied by the eMBMS service of the base station.

With reference to the third aspect, and any one of the first to the eighth possible implementations of the third aspect, in a ninth possible implementation, the load information received by the receiving module is overall load information of the base station and/or load information of the cells served by the base station.

With reference to the third aspect and any one of the first to the ninth possible implementations of the third aspect, in a tenth possible implementation, the MCE further includes a first sending module, configured to: before the load information is received, send a query request to the base station, where the query request is used for instructing the base station to send the load information.

With reference to the third aspect and any one of the first to the tenth possible implementations of the third aspect, in an eleventh possible implementation, when the base station and the MCE are in a same communications network, the load information is carried in M2 interface protocol signaling.

With reference to the eleventh possible implementation of the third aspect, in a twelfth possible implementation, the M2 interface protocol signaling is any one or more of the following signaling: interface reset signaling; interface setup signaling; error indication signaling; configuration update signaling; and eMBMS scheduling information signaling.

With reference to the third aspect and any one of the first to the tenth possible implementations of the third aspect, in a thirteenth possible implementation, when the base station and the MCE are in different communications networks, the load information is carried in a radio access network information management RIM message.

With reference to the third aspect and any one of the first to the thirteenth possible implementations of the third aspect, in a fourteenth possible implementation, the MCE further includes a second sending module, configured to send QoS information to the base station.

A fourth aspect provides a base station, where the base station includes an obtaining module, configured to obtain load information; and a sending module, configured to send the load information to a multimedia broadcast multicast service coordination entity (MCE), where the load information is used for guiding the MCE through eMBMS resource management.

In a first possible implementation of the fourth aspect, the load information is overall load information of the base station and/or load information of cells served by the base station.

With reference to the fourth aspect and the first possible implementation of the fourth aspect, in a second possible implementation, the base station further includes a first receiving module, configured to: before the load information is sent to the MCE, receive a query request from the MCE, where the query request is used for instructing the sending module to send the load information.

With reference to the fourth aspect and any one of the first and the second possible implementations of the fourth aspect, in a third possible implementation, when the base station and the MCE are in a same communications network, the load information is carried in M2 interface protocol signaling.

With reference to the third possible implementation of the fourth aspect, in a fourth possible implementation, the M2 interface protocol signaling is any one or more of the following signaling interface reset signaling; interface setup signaling; error indication signaling; configuration update signaling; and eMBMS scheduling information signaling.

With reference to the fourth aspect and any one of the first and the second possible implementations of the fourth aspect, in a fifth possible implementation, when the base station and the MCE are in different communications networks, the load information is carried in a radio access network information management RIM message.

With reference to the fourth aspect and any one of the first to the fifth possible implementations of the fourth aspect, in a sixth possible implementation, the base station further includes: a second receiving module, configured to receive QoS information from the MCE.

Embodiments of the present invention have a number of beneficial effects. By means of the foregoing solutions, the eMBMS can be effectively managed, thereby eliminating or reducing conflicts between the eMBMS and another service to enable the two services to run in coordination with each other.

Exemplary embodiments will be described in detail with reference to the following accompanying drawings, to make other features and aspects of the present invention clearer.

### BRIEF DESCRIPTION OF THE DRAWINGS

The accompanying drawings that are included in the specification and constitute a part of the specification show exemplary embodiments, features, and aspects of the present invention together with the specification, and are used to explain the principle of the present invention.

FIG. 1 is a diagram illustrating a conventional logical architecture of the eMBMS;

FIG. 2 is a flowchart of an eMBMS management method according to an embodiment of the present invention;

FIG. 3 is a flowchart of an eMBMS management method according to another embodiment of the present invention;

FIG. 4 is a structural diagram of an eMBMS management apparatus according to an embodiment of the present invention;

FIG. 5 is a structural diagram of an eMBMS management apparatus according to an implementation of an embodiment of the present invention;

FIG. 6 is a structural diagram of an eMBMS management apparatus according to another implementation of an embodiment of the present invention;

FIG. 7 is a structural diagram of an eMBMS management apparatus according to another implementation of an embodiment of the present invention;

FIG. 8 is a structural diagram of an eMBMS management apparatus according to another implementation of an embodiment of the present invention;

FIG. 9 is a structural diagram of an eMBMS management apparatus according to another implementation of an embodiment of the present invention;

FIG. 10 is a structural diagram of an eMBMS management apparatus according to another embodiment of the present invention;

FIG. 11 is a structural diagram of an eMBMS management apparatus according to an implementation of another embodiment of the present invention;

FIG. 12 shows a structural diagram of an eMBMS management apparatus according to another implementation of another embodiment of the present invention;

FIG. 13 is a structural diagram of an eMBMS management device according to an embodiment of the present invention; and

FIG. 14 is a structural diagram of an eMBMS management device according to another embodiment of the present invention.

### DETAILED DESCRIPTION OF ILLUSTRATIVE EMBODIMENTS

The following describes various exemplary embodiments, features, and aspects of the present invention in detail with reference to the accompanying drawings. Same or similar components are indicated by a same reference numeral in the accompanying drawings. Various aspects of the embodiments are illustrated in the accompanying drawings, however, unless otherwise stated, there is no need to draw the accompanying drawings to scale.

The term “exemplary” means being used as an example or an embodiment, or serving an illustrative purpose. Any “exemplary” embodiment described herein shall not be construed as being better or advantageous over other embodiments.

Furthermore, in the following specific implementations, numerous specific details are set forth to provide a better understanding of the present invention. A person skilled in the art should understand that, the present invention may also be practiced without these specific details. In some other embodiments, the method, approach, component, and circuit that are known to all are not described in detail, so as to focus on the purport of the present invention.

A first embodiment (Embodiment 1) will be described now.

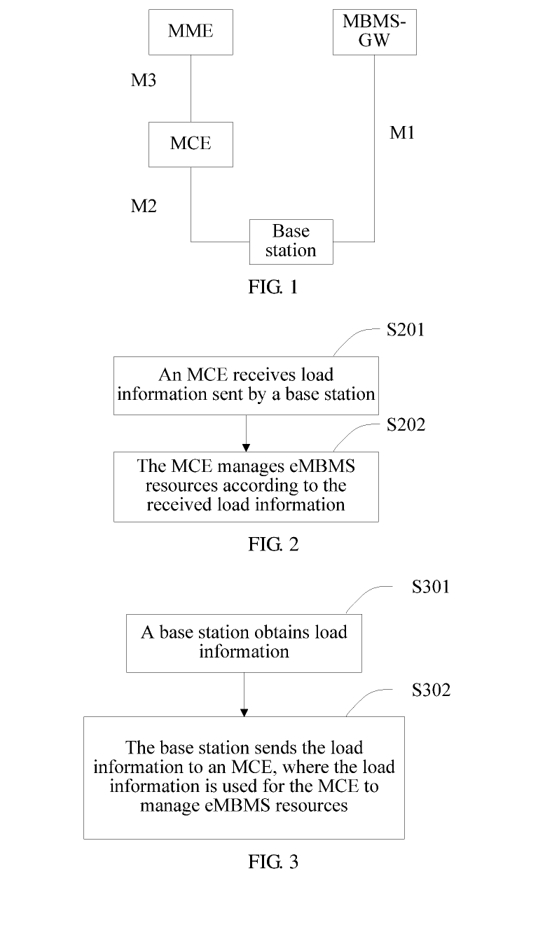

FIG. 2 is a flowchart of an eMBMS management method according to an embodiment of the present invention. As shown in FIG. 2, the method in this embodiment includes the following steps.

S201: An MCE receives load information sent by a base station.

S202: The MCE manages eMBMS resources according to the received load information.

By means of the method in this embodiment, the MCE can dynamically manage eMBMS resources according to the load information sent by the base station, and therefore dynamically coordinate the running of the eMBMS with the running of another service, thereby solving the prior art problem of the two services conflicting with each other.

The base station may send the load information to the MCE proactively or in response to a query request sent by the MCE.

The load information may reflect a load level of the base station, or reflect load levels of cells served by the base station (in other words, in coverage area of the base station), or reflect both of them. Besides, the load information may further reflect an overall load level of an MBSFN area in which the base station is located.

According to different content indicated by the load information, the MCE may perform various adjustments adequately. The adjustment principle is that: when the base station or the MBSFN area has a high load level, amount of resources occupied by the eMBMS service is reduced, so that the reduced amount of resources may be used for another service, such as a unicast service; and when the base station or the MBSFN area has a low load level, amount of resources occupied by the eMBMS service is increased, so that a user of the eMBMS service may be better served if permitted. The following provides several exemplary implementations of how the MCE manages eMBMS resources according to the received load information.

A first implementation (Implementation 1) will be described now.

In a possible implementation, the load information may reflect the load level of the base station, and when the load information indicates that the load level of the base station is greater than or equal to a first threshold, the MCE makes the base station exit the multicast/broadcast over single frequency network (MBSFN) area, or makes at least one of the cells served by the base station exit the MBSFN area. The act of exiting is equivalent to releasing a resource of the base station, so that the exiting base station or cell no longer participates in the eMBMS service, and the released resource is used by another service (for example, a unicast service with a higher priority), thereby effectively adjusting resource occupied by the eMBMS.

A base station may be selected as an exiting unit, or a cell may be used as an exiting unit, depending on a practical situation. For example, if a load level of only a particular cell served by the base station exceeds a threshold and the base station can take care of its load adequately, the cell whose load level exceeds the threshold may be made to exit the MBSFN area. If an overall load level of the base station exceeds a threshold, a cell served by the base station may be selected, according to a preset principle, to exit the MBSFN area, even until the whole base station exits the MBSFN area; or the whole base station may be made to exit the MBSFN area.

As an example, at least one of the cells is made to exit the MBSFN area according to a descending order of the load levels of the cells, that is, a cell with a high load level is preferentially made to exit the MBSFN area. In another example, a threshold may be set, and a cell whose load level exceeds the threshold is made to exit the MBSFN area. In addition, it can be understood that, making a cell exit the MBSFN area may also include a case of setting the cell as a reserved cell (MBSFN AREA RESERVED CELL, namely, a cell in which the MBFSN service is not transmitted and another service is allowed to be transmitted).

This implementation may further include: when the load information indicates that the load level of the base station is less than or equal to a second threshold, making, by the MCE, the base station or at least one cell served by the base station join the MBSFN area. In an example, the base station or cell that is made to exit may be preferentially selected to join the MBSFN area.

The first threshold may or may not be different from the second threshold.

A second implementation (Implementation 2) will be described now.

In a possible implementation, the MCE may determine the overall load level of the MBSFN area according to the received load information, and when the overall load level of the MBSFN area is greater than or equal to a third threshold, the MCE reduces an amount of resources occupied by the eMBMS service in the MBSFN area.

This implementation may further include, when the overall load level of the MBSFN area is less than or equal to a fourth threshold, increasing, by the MCE, the amount of resources occupied by the eMBMS service in the MBSFN area.

In the foregoing implementation, the amount of resources occupied by the eMBMS can be adjusted based on the overall load level of the MBSFN area. Consequently, when the overall load level is high, a part of resources occupied by the eMBMS service can be released, and the released resources can be used by another service, thereby solving the problem of the two service conflicting with each other. Adjusting the whole MBSFN area facilitates unified planning and avoids discontinuity of channels in the area.

The overall load level of the MBSFN area may be determined according to load information sent by all base stations in the MBSFN area. As an example, load levels of the base stations may be accumulated to obtain the overall load level of the MBSFN area. However, the present invention is not limited thereto. For example, the overall load level of the MBSFN area may also be calculated based on the load levels of the base stations and according to another preset method, such as weighted summation.

The third threshold may or may not be different from the fourth threshold.

A third implementation (Implementation 3) will be described now.

According to a possible implementation, when the load information indicates that the load level of the base station is greater than or equal to a fifth threshold, the MCE reduces the amount of resources occupied by the eMBMS service of the base station.

This implementation may further include: when the load information indicates that the load level of the base station is less than or equal to a sixth threshold, the MCE increases the amount of resources occupied by the eMBMS service of the base station.

Compared with implementation 2, in implementation 3, a base station instead of the whole MBSFN area is adjusted, which makes the adjustment more flexible.

The fifth threshold may or may not be different from the sixth threshold.

As an example of implementations 2 and 3, the amount of resources occupied by the eMBMS service of the base station (or the whole MBSFN area) may be adjusted (reduced or increased) by adding the load information of the base station as an adjustment parameter, in addition to being based on a conventional M2AP protocol procedure. For example, based on a conventional mode of eMBMS resource dynamic allocation, the number of subframes in the base station or the MBSFN area may be dynamically modified (for example, reduced or increased) according to a change in the load level of the base station (and/or a cell) or the overall load level of the MBSFN area, so as to adjust (for example, reduce or increase) resource occupied by the eMBMS service, where the load level of the base station (and/or a cell) or the overall load level of the MBSFN area is indicated by the load information.

The foregoing implementations 1, 2, and 3 are three exemplary implementations of how the MCE manages eMBMS resources according to the received load information. However, the present invention is not limited thereto. According to different content indicated by the load information, different measures may be taken to adjust eMBMS resources provided that these measures conform to the foregoing adjustment principle.

Generally, any information that can reflect a load state of the base station can be sent as the load information. The load information may include but is not limited to a combination of any one or more of the following: resource occupation by a cell/base station, number of cell users, QoS satisfaction with user services, service delay, transmission resource occupation rate, CPU usage rate, cell interference level, downlink power utilization rate, and cell spectrum efficiency.

Different load information may reflect the load level of a cell or the base station based on different resources. For example, a usage level of a resource shared by base stations, such as a transmission resource occupation rate, may directly reflect the overall load level of the base station. A usage level of a cell-independent resource, such as the number of cell users in a particular cell, may directly reflect a load level of the particular cell, and the total number of cell users in all cells may also be regarded as reflecting the load level of the base station.

The load information may be sent by the base station to the MCE in various manners. The following describes several exemplary implementations of how the base station sends the load information to the MCE.

A fourth implementation (Implementation 4) will be described now.

In a possible implementation, when the base station and the MCE are in a same communications network, the load information is carried in M2 interface protocol signaling.

An advantage of using protocol-defined signaling is that the load information can be carried in the defined signaling without a need to change a protocol procedure between the base station and the MCE.

Correspondingly, the query request sent by the MCE to the base station may also be carried in M2 interface protocol signaling.

In a case in which the base station reports the load information by using protocol-defined signaling, the M2 interface protocol signaling that may be selected for reporting the load information includes but is not limited to: interface reset signaling (Reset, interface Setup signaling (M2 Setup), error indication signaling (Error Indication), configuration update signaling (Configuration Update), and MBMS scheduling information signaling (MBMS Scheduling Information).

Generally, signaling associated with a non-eMBMS service may be selected as signaling used for carrying the load information, so as to transmit the load information without affecting the eMBMS service. As an example, configuration update signaling is selected to report the load information, that is, the load information is carried in configuration update signaling. An advantage of this implementation is that transmission of configuration update signaling is on a periodic basis and the MCE can periodically receive the load information reported by the base station, so as to periodically adjust eMBMS resources dynamically. However, the present invention is not limited thereto. For example, when the MBSFN area is initially established and the base station enters and exits the MBSFN area, the load information may also be carried in a related protocol message. Compared with the prior art in which an M2 interface protocol is not used to transmit the load information of the base station to the MCE, this embodiment makes an optimization to content of M2 interface protocol signaling, to enable the MCE to effectively perform resource coordination based on the load information.

In a possible implementation, an information element already defined in an M2 interface protocol may be used as the load information.

Generally, an information element may be selected provided that the information element can reflect necessary load information of the base station. For example, defined information elements that may be selected include but are not limited to a combination of any one or more of the following: information element (Composite Available Capacity Group) reflecting composite available capacity, information element (LOAD INFORMATION) reflecting an interference level, information element (Hardware Load Indicator) reflecting a hardware load, information element (S1 TNL Load Indicator) reflecting a transmission load, information element (Load Indicator) reflecting a load level (low, intermediate, high, or overload), and information element (Radio Resource Status) reflecting a radio resource status (to indicate a PRB utilization rate).

The “Composite Available Capacity Group” information element includes cell-level and overall E-UTRAN (evolved universal terrestrial radio access network) resource information, and is identified by linear numerical values 1 to 100. In an example, the “Composite Available Capacity Group” information element is used as the load information. An advantage of the “Composite Available Capacity Group” information element is that the “Composite Available Capacity Group” information element can reflect both load levels of cells covered by the base station and the overall load level of the base station.

A fifth implementation (Implementation 5) will be described now.

In a possible implementation, when the base station and the MCE are in different communications networks, the load information is carried in a radio access network information management RIM message.

The MCE may obtain load information in another communications network based on an RIM (RAN Information Management, radio access network information management) procedure. RIM is a procedure defined in protocols, such as 6.413/48.018 to allow entities in radio access networks to exchange information through a core network, and the RIM includes a procedure in which an LTE communications network system provides a load state of the LTE communications network system to a different surrounding system (for example, a communications network system such as a GSM system). In this case, both the query request sent by the MCE and the load information reported by the base station may be carried in an RIM message for transmission.

For example, in a possible implementation, the requesting party MCE may use an RIM message procedure to send the query request to the reporting party, base station, on an M2 interface by using a self-defined RIM message (for example, for the RIM message procedure and format, reference may be made to a case in which an MME sends an RIM message to an eNB to obtain load information), and receive the load information that the reporting party base station sends by using a self-defined RIM message.

In another possible implementation, the requesting party MCE may also forward the query request through a reporting party MME. For example, the requesting party MCE may simulate itself as a network element of a different system, and send the query request to the reporting party MME on an M3 interface by using a self-defined RIM message with reference to an RIM procedure between a network element of a different system and the MME. The reporting party MME may forward the query request to the base station through an S1 interface between the MME and the base station by using a normal RIM procedure, receive the load information, and then send the load information to the requesting party MCE through the M3 interface by using a self-defined RIM message.

In the foregoing two implementations, the requesting party MCE may obtain the load information of the reporting party by using an RIM procedure, and then perform resource management among different communications network systems based on the load information. For example, when a base station in a communications network system in which the reporting party is located has an excessively high load level, a part of multicast or unicast services may be transferred to the requesting party to implement resource coordination.

Implementations 4 and 5 are two possible implementations of how the MCE receives the load request of the base station. However, the present invention is not limited thereto. For example, the base station may send the load information to the MCE by using a self-defined message, or the MCE sends a query request to the base station by using a self-defined message. The content, reporting time/cycle, reporting triggering condition, and so on of the self-defined message may be self-defined by a user provided that the load information can be reported to the MCE.

As described above, the load information can indicate a load level (for example, the load level of the base station, a load level of a cell, or the overall load level of the MBSFN area). A specific procedure in which the MCE determines the load level may vary depending on specific content of the load information. Several possible implementations are provided in the following.

In a possible implementation, the load information is original information (for example, an information element defined in an M2 interface protocol) that can be directly obtained by the base station. In this case, after receiving the original information, the MCE may calculate, according to a preset calculation method, a determining value for determining the load level, compare the determining value with a preset threshold (for example, a high threshold and a low threshold) to obtain a determining result, and then perform eMBMS resource management according to the determining result. The calculation method includes but is not limited to: calculating a percentage ratio of a load level to an allowed maximum load level, using the percentage ratio as the determining value, or calculating the determining value according to a preset algorithm and based on multiple different parameters that are in the load information and reflect the load level, or directly using a parameter value as the determining value without calculation, where the used parameter value is included in an information element and indicates the load level.

In another possible implementation, the base station may first perform calculation processing based on original load information, and then report a calculation processing result (for example, the determining value described above) to the MCE as the load level. The MCE may determine whether the load level is high or low according to the calculation result.

In another possible implementation, the base station may also perform calculation and determining processing on the original load information, and report a determining result to the MCE. The MCE may directly perform eMBMS resource management according to the determining result. An advantage of this possible implementation is that the operating burden of the MCE may be reduced.

However, generally, a standard and method for determining whether the load level is high or low may be defined as needed, and are not limited to the foregoing implementations.

A second embodiment (Embodiment 2) will be described now.

FIG. 3 shows an evolved multimedia broadcast multicast service (eMBMS) management method according to a second embodiment of the present invention. The method includes the following steps.

S301: A base station obtains load information.

S302: The base station sends the load information to a multimedia broadcast multicast service coordination entity (MCE), where the load information is used for the MCE to manage eMBMS resources.

By means of the method in this embodiment, the MCE can dynamically manage eMBMS resources according to the load information sent by the base station, and therefore dynamically coordinate the running of the eMBMS with the running of another service, thereby solving the prior art problem of the two services conflicting with each other.

In a possible implementation, the load information is overall load information of the base station and/or load information of cells served by the base station.

In a possible implementation, before the base station sends the load information to the MCE, the method further includes: receiving, by the base station, a query request from the MCE, where the query request is used for instructing the base station to send the load information.

In a possible implementation, when the base station and the MCE are in a same communications network, the load information is carried in M2 interface protocol signaling.

In a possible implementation, when the base station and the MCE are in different communications networks, the load information is carried in a radio access network information management RIM message.

A third embodiment (Embodiment 3) will be described now.

In the prior art, QoS (quality of service) information of the eMBMS is transmitted to an MCE by an MME on an M3 interface. The MCE performs service admission and scheduling according to air interface bandwidth. When performing transmission admission, a base station does not obtain required QoS information.

Based on Embodiment 1 and Embodiment 2, in this embodiment, the MCE sends QoS information to the base station (or the base station receives QoS information from the MCE), so that the base station can perform admission decision and overload control on the eMBMS more accurately according to the QoS information transmitted by the MCE.

In a possible implementation, the QoS information transmitted by the MCE may include QoS information required by the base station to perform admission decision and overload control on the eMBMS, such as a QCI (QoS class identifier) and a GBR (guaranteed bit rate).

In a possible implementation, a defined information element containing the QoS information may be attached to conventional signaling that conforms to an M2 interface protocol, so as to send the information element to the base station. For example, an MBMS E-RAB QoS parameters information element defined in an M2 interface protocol (for example, the 36.444 protocol) is attached to session start request signaling, and the information element is forwarded to the base station through the MCE. However, the present invention is not limited thereto. For example, a self-defined information element that carries necessary QoS information may also be used to replace a protocol-defined information element, or self-defined signaling may also be used to replace protocol-defined signaling. Self-defined signaling and its content, transmission time/cycle, triggering condition, and so on may be self-defined according to an actual need.

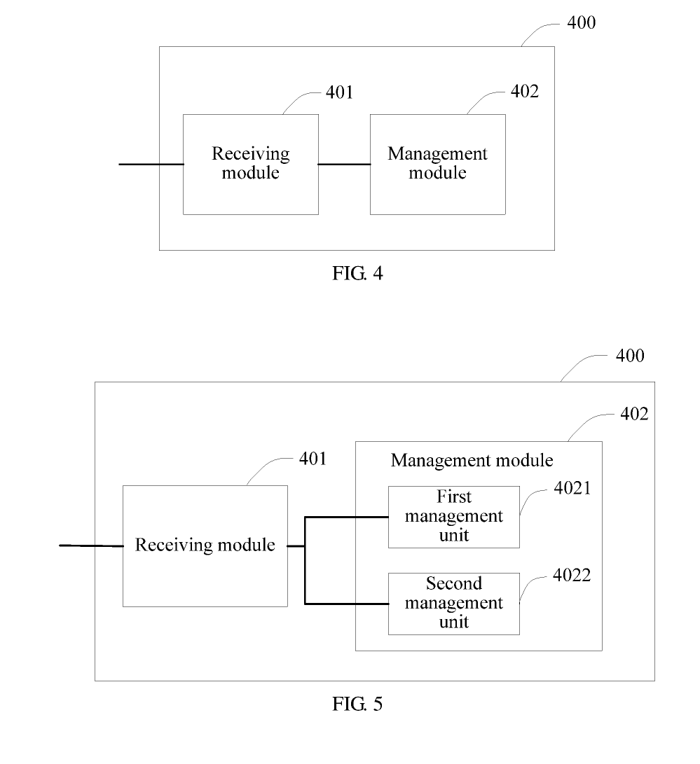

FIG. 4 shows a multimedia broadcast multicast service coordination entity (MCE) 400 according to a fourth embodiment of the present invention. A receiving module 401 is configured to receive load information sent by a base station. A management module 402 is configured to manage eMBMS resources according to the received load information.

In this embodiment, the MCE can dynamically manage eMBMS resources according to the load information sent by the base station, and therefore dynamically coordinate the running of the eMBMS with the running of another service, thereby solving the prior art problem of the two services conflicting with each other.

Several exemplary implementations of the management module 402 are provided in the following.

In a possible implementation shown in FIG. 5, the management module 402 includes a first management unit 4021, configured to: when the load information indicates that a load level of the base station is greater than or equal to a first threshold, make the base station exit a multicast/broadcast over single frequency network (MBSFN) area, or make at least one cell served by the base station exit the MBSFN area. The act of exiting is equivalent to releasing a resource of the base station, so that the exiting base station or cell no longer participates in the eMBMS service, and the released resource is used by another service (for example, a unicast service with a higher priority), thereby effectively adjusting resource occupied by the eMBMS.

In an example, the first management unit 4021 may make, according to a descending order of loads of the cells, at least one of the cells served by the base station exit the MBSFN area, that is, a cell with a high load level is preferentially made to exit the MBSFN area. In another example, a threshold may also be set, and a cell whose load level exceeds the threshold is made to exit the MBSFN area. In addition, it can be understood that making a cell exit the MBSFN area may also include a case of setting the cell as a reserved cell (MBSFN AREA RESERVED CELL, namely, a cell in which the MBFSN service is not transmitted and which is allowed to transmit another service).

In an example, the management module may further include a second management unit 4022, configured to: when the load information indicates that the load level of the base station is less than or equal to a second threshold, make the base station or at least one of the cells served by the base station join the MBSFN area.

The first threshold may or may not be different from the second threshold.

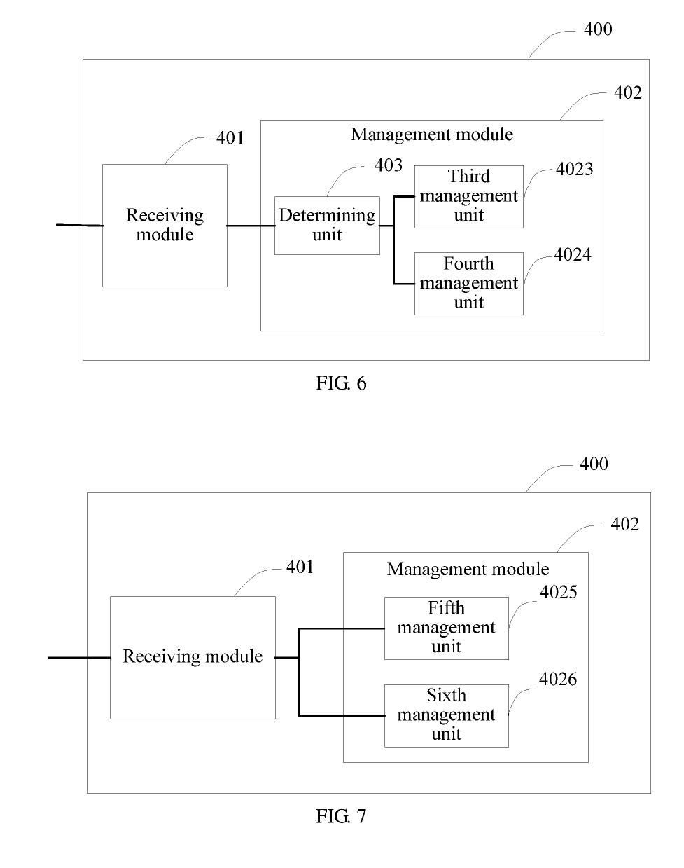

In another possible implementation shown in FIG. 6, the management module 402 may include a determining unit 403. The determining unit 403 is configured to determine an overall load level of the MBSFN area according to the load information; and the management module may further include a third management unit 4023, configured to: when the overall load level of the MBSFN area is greater than or equal to a third threshold, reduce an amount of resources occupied by the eMBMS service in the MBSFN area.

In an example, the management module 402 may further include a fourth management unit 4024, configured to: when the overall load level of the MBSFN area is less than or equal to a fourth threshold, increase the amount of resources occupied by the eMBMS service in the MBSFN area. In the foregoing implementation, the amount of resources occupied by the eMBMS can be adjusted based on the overall load level of the MBSFN area, so that when the overall load level is high, a part of resources occupied by the eMBMS service can be released, and the released resources are used by another service, thereby solving the problem of the two services conflicting with each other. Adjusting the whole MBSFN area facilitates unified planning and avoids discontinuity of channels in the area.

The third threshold may or may not be different from the fourth threshold.

In another possible implementation shown in FIG. 7, the management module 402 may include a fifth management unit 4025, configured to: when the load information indicates that the load level of the base station is greater than or equal to a fifth threshold, reduce the amount of resources occupied by the eMBMS service of the base station.

In an example, the management module 402 may further include a sixth management unit 4026, configured to: when the load information indicates that the load level of the base station is less than or equal to a sixth threshold, increase the amount of resources occupied by the eMBMS service of the base station.

In this possible implementation, the base station instead of the whole MBSFN area is adjusted as an unit, which makes the adjustment more flexible.

The fifth threshold may or may not be different from the sixth threshold.

The foregoing implementations are three exemplary implementations of how the management module 402 manages eMBMS resources according to the received load information. However, the present invention is not limited thereto. According to different content indicated by the load information, the management module 402 may take different measures to adjust eMBMS resources provided that these measures conform to the foregoing adjustment principle.

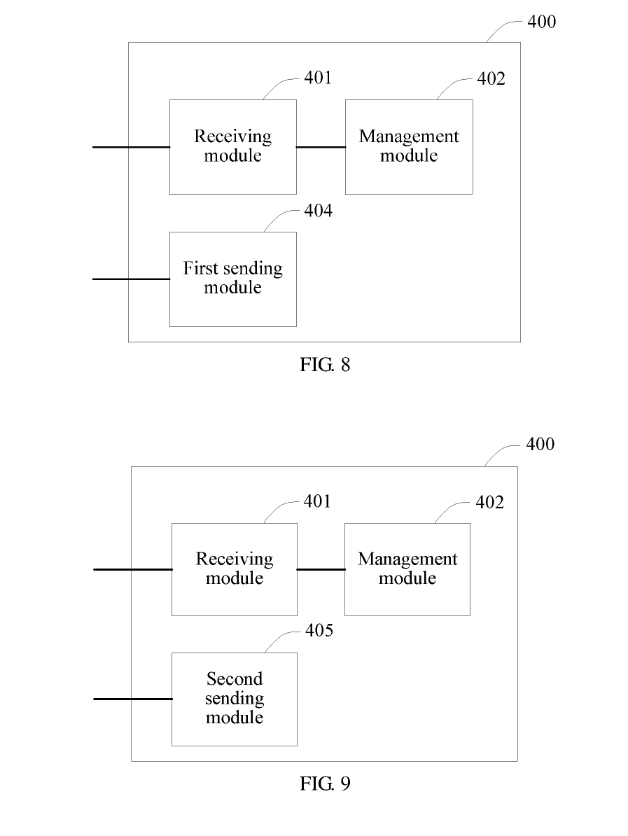

In a possible implementation shown in FIG. 8, the MCE 400 further includes a first sending module 404, configured to, before the load information is received, send a query request to the base station, where the query request is used for instructing the base station to send the load information, and the load information may be overall load information of the base station and/or load information of cells served by the base station.

In a possible implementation, when the base station and the MCE are in a same communications network, the load information is carried in M2 interface protocol signaling.

M2 interface protocol signaling that may be selected for reporting the load information includes but is not limited to: interface reset signaling, interface setup signaling, error indication signaling, configuration update signaling, and eMBMS scheduling information signaling.

Generally, signaling associated with a non-eMBMS service may be selected as signaling used for carrying the load information, so as to transmit the load information without affecting the eMBMS service.

In another possible implementation, when the base station and the MCE are in different communications networks, the load information is carried in a radio access network information management RIM message.

In a possible implementation shown in FIG. 9, the MCE further includes a second sending module 405, configured to send QoS information to the base station.

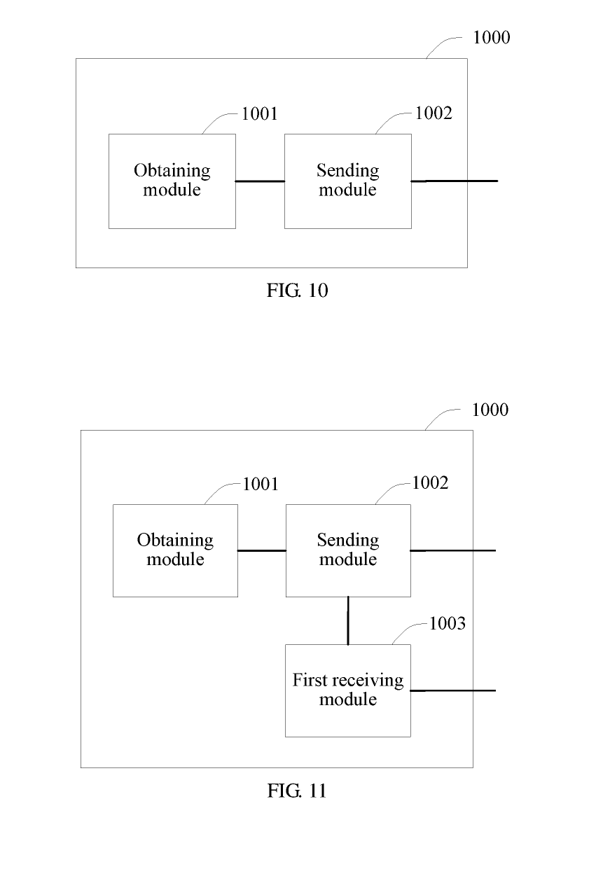

FIG. 10 shows a base station 1000 according to an embodiment of the present invention. The base station includes an obtaining module 1001, which is configured to obtain load information, and a sending module 1002, which is configured to send the load information to a multimedia broadcast multicast service coordination entity (MCE), where the load information is used for the MCE to manage eMBMS resources.

With the aid of the base station in this embodiment, the MCE can dynamically manage eMBMS resources according to the load information sent by the base station, and therefore dynamically coordinate the running of the eMBMS with the running of another service, thereby solving the prior art problem of the two services conflicting with each other.

In a possible implementation, the load information is overall load information of the base station and/or load information of cells served by the base station.

In a possible implementation shown in FIG. 11, the eMBMS management apparatus further includes a first receiving module 1003, which is configured to, before the load information is sent to the MCE, receive a query request from the MCE. The query request is used for instructing the sending module to send the load information.

In a possible implementation, when the base station and the MCE are in a same communications network, the load information is carried in M2 interface protocol signaling.

M2 interface protocol signaling that may be selected for reporting the load information includes but is not limited to: interface reset signaling, interface setup signaling, error indication signaling, configuration update signaling, and eMBMS scheduling information signaling.

Generally, signaling associated with a non-eMBMS service may be selected as signaling used for carrying the load information, so as to transmit the load information without affecting the eMBMS service.

In a possible implementation, when the base station and the MCE are in different communications networks, the load information is carried in a radio access network information management RIM message.

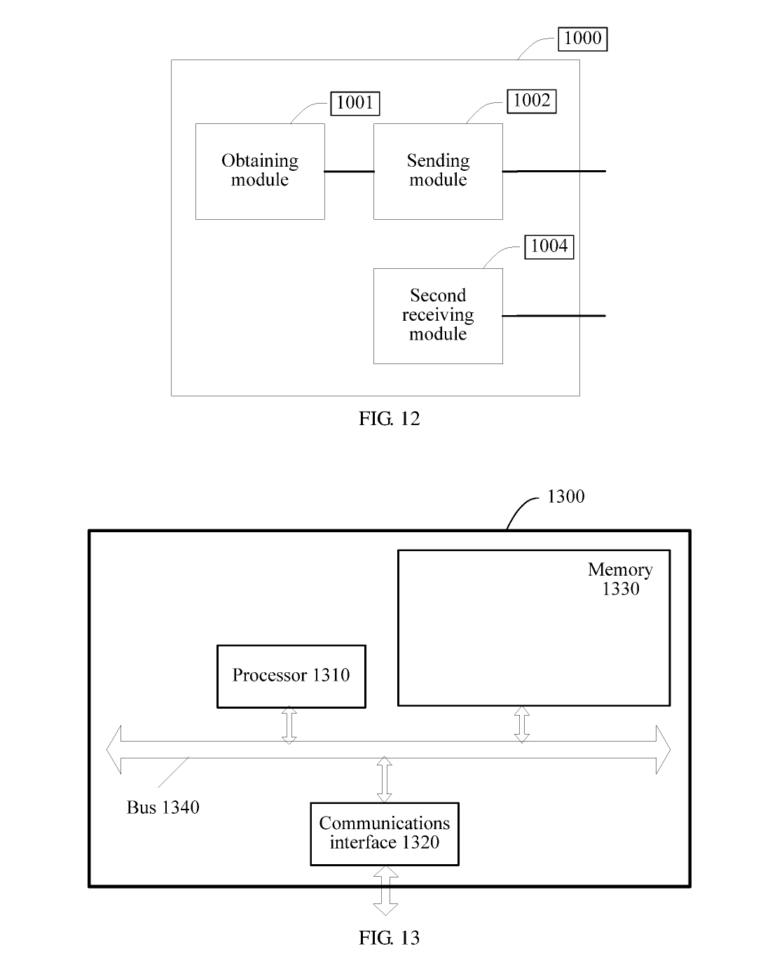

In a possible implementation shown in FIG. 12, the eMBMS management apparatus further includes a second receiving module 1004, configured to receive QoS information from the MCE.

FIG. 13 shows a structural block diagram of an eMBMS management device according to another embodiment of the present invention. The eMBMS management device 1300 may be a host server, a personal computer PC, a portable computer, a terminal, or the like that has a computing capability. Specific implementations of a computing node are not limited in specific embodiments of the present invention.

The eMBMS management device 1300 includes a processor 1310, a communications interface 1320, a memory 1330, and a bus 1340. The processor 1310, the communications interface 1320, and the memory 1330 communicate with each other by using the bus 1340.

The communications interface 1320 is configured to communicate with a network element, where the network element includes, for example, a virtual machine management center, a shared storage, or the like.

The processor 1310 is configured to execute a program. The processor 1310 may be a central processing unit CPU, an application specific integrated circuit ASIC (Application Specific Integrated Circuit), or one or more integrated circuits configured to implement the embodiments of the present invention.

The memory 1330 is configured to store a file. The memory 1330 may include a high-speed RAM memory, and may also include a non-volatile memory, for example, at least one disk memory. The memory 1330 may also be a memory array. The memory 1330 may also be divided into blocks, and the blocks may be combined to form a virtual volume according to a certain rule.

In a possible implementation, the program may include program code instructing a computer operation. The program may specifically be configured to execute each step of the methods in embodiment 1 or 3.

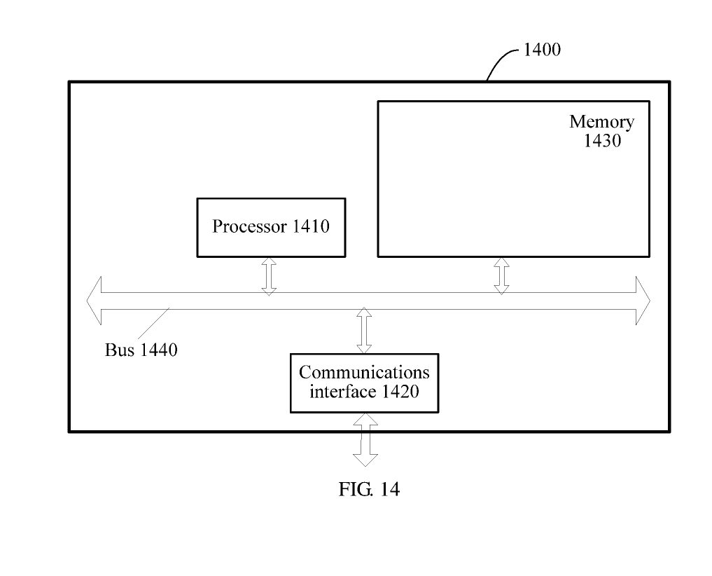

FIG. 14 shows a structural block diagram of an eMBMS management device according to another embodiment of the present invention. The eMBMS management device 1400 may be a host server, a personal computer PC, a portable computer, a terminal, or the like that has a computing capability. Specific implementations of a computing node are not limited in specific embodiments of the present invention.

The eMBMS management device 1400 includes a processor 1410, a communications interface 1420, a memory 1430, and a bus 1440. The processor 1410, the communications interface 1420, and the memory 1430 communicate with each other by using the bus 1440.

The communications interface 1420 is configured to communicate with a network element, where the network element includes, for example, a virtual machine management center, a shared storage, or the like.

The processor 1410 is configured to execute a program. The processor 1410 may be a central processing unit CPU, an application specific integrated circuit ASIC (Application Specific Integrated Circuit), or one or more integrated circuits configured to implement the embodiments of the present invention.

The memory 1430 is configured to store a file. The memory 1430 may include a high-speed RAM memory, and may also include a non-volatile memory, for example, at least one disk memory. The memory 1430 may also be a memory array. The memory 1430 may also be divided into blocks, and the blocks may be combined to form a virtual volume according to a certain rule.

In a possible implementation, the program may include program code instructing a computer operation. The program may specifically be configured to execute each step of the methods in embodiment 2 or 3.

A person of ordinary skill in the art may be aware that, the exemplary units and algorithm steps described in the embodiments disclosed in this specification may be implemented by electronic hardware, or by a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

When the functions are implemented in a form of computer software and sold or used as an independent product, all or a part of the technical solutions of the present invention (for example, the part contributing to the prior art) may be implemented in the form of a computer software product. The computer software product is stored in a computer readable storage medium and includes several instructions for instructing a computer device (which may be a personal computer, a server, or a network device) to perform all or a part of the steps of the methods described in the embodiments of the present invention. The storage medium includes any medium that can store program code, such as a USB flash drive, a removable hard disk, a read-only memory (ROM), a random access memory (RAM), a magnetic disk, or an optical disc.

The foregoing descriptions are merely specific implementations of the present invention, but are not intended to limit the protection scope of the present invention. Using the present invention for a heterogeneous LTE-A network may also be considered. Any variation or replacement readily figured out by a person skilled in the art within the technical scope disclosed in the present invention shall fall within the protection scope of the present invention. Therefore, the protection scope of the present invention shall be subject to the protection scope of the claims.

The eMBMS management method, apparatus, and device provided according to the embodiments of the present invention are applicable to the wireless communications field, and in particular, applicable to a scenario in which an LTE system supports both the eMBMS and another service, such as unicast. The eMBMS management method, apparatus, and device can effectively manage the eMBMS, thereby eliminating or reducing conflicts between the eMBMS and another service to enable the two services to run in coordination with each other.

What is claimed is:

1. An evolved multimedia broadcast multicast service (eMBMS) management method, wherein the method comprises:
receiving, by a multimedia broadcast multicast service coordination entity (MCE), load information sent by a base station; and
managing, by the MCE, eMBMS resources according to the load information sent by the base station.

2. The eMBMS management method according to claim 1, wherein the load information indicates that a load level of the base station is greater than or equal to a first threshold and wherein managing the eMBMS resources comprises removing, by the MCE, the base station from a multicast/broadcast over single frequency network (MBSFN) area, or removing at least one cell served by the base station from an MBSFN area.

3. The eMBMS management method according to claim 1, wherein the load information indicates that a load level of the base station is greater than or equal to a first threshold and wherein managing the eMBMS resources comprises removing, by the MCE and according to a descending order of loads of cells, at least one cell of the cells served by the base station from an MBSFN area.

4. The eMBMS management method according to claim 1, wherein the load information indicates that a load level of the base station is less than or equal to a second threshold and wherein managing the eMBMS resources according to the load information sent by the base station further comprises adding, by the MCE, the base station or at least one cell served by the base station to an MBSFN area.

5. The eMBMS management method according to claim 1, wherein managing the eMBMS resources according to the load information sent by the base station comprises:
determining that an overall load level of an MBSFN area is greater than or equal to a third threshold, the overall load level being determined according to the load information; and
reducing, by the MCE, an amount of resources occupied by the eMBMS service in the MBSFN area.

6. The eMBMS management method according to claim 1, wherein managing the eMBMS resources according to the load information sent by the base station comprises:
determining that overall load level of an MBSFN area is less than or equal to a fourth threshold, the overall load level being determined according to the load information; and
increasing an amount of resources occupied by the eMBMS service in the MBSFN area.

7. The eMBMS management method according to claim 1, wherein the load information indicates that a load level of the base station is greater than or equal to a fifth threshold and wherein managing the eMBMS resources according to the load information sent by the base station comprises reducing, by the MCE, an amount of resources occupied by the eMBMS service of the base station.

8. The eMBMS management method according to claim 1, wherein the load information indicates that a load level of the base station is less than or equal to a sixth threshold and wherein managing the, eMBMS resources according to the load information sent by the base station comprises increasing, by the MCE, an amount of resources occupied by the eMBMS service of the base station.

9. A multimedia broadcast multicast service coordination entity (MCE), comprising:
a processor; and
a non-transitory computer-readable storage medium storing a program to be executed by the processor, the program including instructions for
receiving load information sent by a base station; and
managing evolved multimedia broadcast multicast service (eMBMS) resources according to the load information sent by the base station.

10. The MCE according to claim 9, wherein the program includes further instructions for, when the load information indicates that a load level of the base station is greater than or equal to a first threshold, removing the base station from a multicast/broadcast over single frequency network (MBSFN) area, or removing at least one cell served by the base station from an MBSFN area.

11. The MCE according to claim 10, wherein the program includes instructions for removing at least one of the cells served by the base station from the MBSFN area according to a descending order of loads of the cells.

12. The MCE according to claim 9, wherein the program includes further instructions for, when the load information indicates that a load level of the base station is less than or equal to a second threshold, add the base station or at least one cell served by the base station to an MBSFN area.

13. The MCE according to claim 9, wherein the program includes further instructions for determining an overall load level of an MBSFN area according to the load information and, when the overall load level of the MBSFN area is greater than or equal to a third threshold, reducing an amount of resources occupied by the eMBMS service in the MBSFN area.

14. The MCE according to claim 9, wherein the program includes further instructions for determining an overall load level of an MBSFN area according to the load information and, when the overall load level of the MBSFN area is less than or equal to a fourth threshold, increasing an amount of resources occupied by the eMBMS service in the MBSFN area.

15. The MCE according to claim 9, wherein the program includes further instructions for, when the load information indicates that a load level of the base station is greater than or equal to a fifth threshold, reducing an amount of resources occupied by the eMBMS service of the base station.

16. The MCE according to claim 9, wherein the program includes further instructions for, when the load information indicates that a load level of the base station is less than or equal to a sixth threshold, increasing an amount of resources occupied by the eMBMS service of the base station.

17. The MCE according to claim 9, wherein the load information received is overall load information of the base station and/or load information of cells served by the base station.

18. The MCE according to claim 9, wherein the program includes further instructions for sending QoS information to the base station.

19. A base station comprising:
a processor; and
a non-transitory computer-readable storage medium storing a program to be executed by the processor, the program including instructions for:
obtaining load information; and
sending the load information to a multimedia broadcast multicast service coordination entity (MCE), wherein the load information is used for the MCE to manage evolved multimedia broadcast multicast service (eMBMS) resources.

20. The base station according to claim 19, wherein the load information is overall load information of the base station and/or load information of cells served by the base station.
